(19) United States
(12) Patent Application Publication
(10) Pub. No.: US 2011/0141458 A1
(43) Pub. Date: Jun. 16, 2011

(54) Coated Optical Fiber Identifying Apparatus and Coated Optical Fiber Identifying Method

(75) Inventors: Takashi Matsui, Ibaraki-ken (JP); Kunihiro Toge, Ibaraki-ken (JP); Toshio Kurashima, Ibaraki-ken (JP); Shigeru Tomita, Ibaraki-ken (JP)

(73) Assignee: NIPPON TELEGRAPH AND TELEPHONE CORPORATION, Tokyo (JP)

(21) Appl. No.: 13/057,271

(22) PCT Filed: Jun. 30, 2009
(86) PCT No.: PCT/JP2009/061976

§ 371 Date: Feb. 2, 2011

(30) Foreign Application Priority Data
Aug. 18, 2008 (JP) 2008-209478

(51) Int. Cl. G01N 21/00

(52) U.S. Cl. 356/73.1

(57) ABSTRACT

A coated optical fiber identifying apparatus is provided, which can realize coated optical fiber identification for a single mode optical fiber with holes. The coated optical fiber identifying apparatus comprises a grating forming tool 20 for forming a grating by applying a force to an optical fiber with a plurality of protrusions 23, and a photo detector 30 for detecting leak light generated in the optical fiber 1, wherein the plurality of the protrusions 23 are arranged in a period Λ within a range of 0.24 mm to 0.75 mm.

### TECHNICAL FIELD

The present invention relates to a coated optical fiber identifying apparatus as a test device for an optical conductive test in an optical transmission system and a coated optical fiber identifying method thereof, and particularly to a coated optical fiber identifying apparatus and a coated optical fiber identifying method using a long period grating.

### BACKGROUND ART

While operations in the construction and maintenance of optical lines increase with the spread of FTTH (Fiber To The Home) services, handling of the conventional optical fibers is poor since tolerable bending radius is large. Therefore, in recent years, various types of optical fibers have been developed, of which tolerable bending radius is made smaller, improving bending loss characteristics. Particularly, since a single mode optical fiber with holes described in PTL 1 has excellent bending loss characteristics as well as excellent connectivity with a conventional single mode fiber, it has been actively researched.

In order to check any of coated optical fibers in the construction and the operation of the optical line, it is required to be able to find any of the coated optical fibers at the work site. Therefore, a coated optical fiber identifying apparatus (for example, refer to PTL 2) has been widely used, since it can tap off a part of light propagated in the optical fiber to see if the optical fiber is a desired optical fiber. The coated optical fiber identifying apparatus determines whether or not the light is propagated in the optical fiber by forming a bending portion in the optical fiber and receiving light leaked from the bending portion.

### Citation List

### Patent Literature

PTL 1: Japanese Patent Publication No. 3854627

PTL 2: Japanese Patent Publication No. 3407812

### SUMMARY OF INVENTION

### Technical Problem

However, the single mode optical fiber with holes shown in Patent Literature 1 has much smaller bending loss as compared to that of the conventional single mode optical fiber, and therefore, a problem exists in that the conventional coated optical fiber identifying method can not be applied, and thus, the coated optical fiber identification can not be conducted.

Therefore, the present invention is made for solving the foregoing problem and it is directed to provide a coated optical fiber identifying apparatus and a coated optical fiber identifying method which can realize coated optical fiber identification to a single mode optical fiber with holes.

### Solution to Problem

A coated optical fiber identifying apparatus according to a first invention for solving the aforementioned problem comprises a grating forming means for forming a grating by applying a force to an optical fiber with a plurality of protrusions, and a photo reception means for detecting leak light generated in the optical fiber.

A coated optical fiber identifying apparatus according to a second invention for solving the aforementioned problem is the coated optical fiber identifying apparatus according to the first invention, wherein a period of the plurality of the protrusions changes along a mounting direction of the optical fiber.

A coated optical fiber identifying apparatus according to a third invention for solving the aforementioned problem is the coated optical fiber identifying apparatus according to the first invention or the second invention, wherein the force is 8N or more.

A coated optical fiber identifying apparatus according to a fourth invention for solving the aforementioned problem is the coated optical fiber identifying apparatus according to one of the first invention to the third invention, further comprises an optical fiber bend applying means for applying bend to the optical fiber, wherein a curvature radius of the bend is within a range of 8 mm to 12 mm.

A coated optical fiber identifying apparatus according to a fifth invention for solving the aforementioned problem is the coated optical fiber identifying apparatus according to one of the first invention to the fourth invention, wherein the plurality of the protrusions are arranged in a period within a range of 0.24 mm to 0.75 mm.

A coated optical fiber identifying apparatus according to a sixth invention for solving the aforementioned problem is the coated optical fiber identifying apparatus according to the fourth invention, wherein the plurality of the protrusions are arranged in the optical fiber bend applying means.

A coated optical fiber identifying method according to a seventh invention for solving the aforementioned problem comprises forming a long period grating by applying a force to an optical fiber with a plurality of protrusions arranged in a period within a range of 0.24 mm to 0.75 mm, and confirming that a light wave is propagating in the optical fiber by detecting leak light generated in the optical fiber.

A coated optical fiber identifying method according to an eighth invention for solving the aforementioned problem is the coated optical fiber identifying method according to the seventh invention, wherein the long period grating is formed by changing an angle between the plurality of the protrusions and the optical fiber.

A coated optical fiber identifying method according to a ninth invention for solving the aforementioned problem is the coated optical fiber identifying method according to the seventh invention or the eighth invention, wherein the leak light generated in the optical fiber is detected by applying bend to the optical fiber.

### Advantageous Effects of Invention

According to the coated optical fiber identifying apparatus and the coated optical fiber identifying method, it is possible to realize the coated optical fiber contract to the single mode optical fiber with holes.

### BRIEF DESCRIPTION OF DRAWINGS

FIG. 1A is a schematic diagram for explaining a coated optical fiber identifying apparatus according to a first embodiment of the present invention;

FIG. 1B is a diagram showing a relation between a refractive index changing amount and a stress applied location by a grating forming tool provided in the coated optical fiber identifying apparatus according to the first embodiment of the present invention;

FIG. 1C is a flow chart for conducting coated optical fiber identification using the coated optical fiber identifying apparatus according to the first embodiment of the present invention;

FIG. 2A is a diagram schematically showing a single mode optical fiber with holes having six holes;

FIG. 2B is a diagram schematically showing a single mode optical fiber with holes having ten holes;

FIG. 3A is a graph showing a relation between a wavelength and a loss spectrum in the coated optical fiber identifying apparatus according to the first embodiment of the present invention;

FIG. 3B is a graph showing a relation between a period of protrusions and a center wavelength (wavelength in which a loss spectrum is maximized) relating to the coated optical fiber identifying apparatus according to the first embodiment of the present invention;

FIG. 4 is a graph showing an example of hole structure dependency of a grating period in HAF relating to the coated optical fiber identifying apparatus according to the first embodiment of the present invention;

FIG. 5A is a graph showing a relation between a core diameter 2a (μm) and a grating period (μm) in HAF relating to the coated optical fiber identifying apparatus according to the first embodiment of the present invention;

FIG. 5B is a graph showing a relation between a relative refractive index difference Δ(%) and a grating period (μm) in HAF relating to the coated optical fiber identifying apparatus according to the first embodiment of the present invention;

FIG. 6A is a graph showing a relation between a normalized hole diameter d/2a and a grating period (μm) in HAF relating to the coated optical fiber identifying apparatus according to the first embodiment of the present invention;

FIG. 6B is a graph showing a relation between a normalized hole diameter d/2a and a grating period (μm) relating to the coated optical fiber identifying apparatus according to the first embodiment of the present invention;

FIG. 6C is a graph showing a relation between a normalized hole diameter d/2a and a grating period (μm) relating to the coated optical fiber identifying apparatus according to the first embodiment of the present invention;

FIG. 6D is a graph showing a relation between a normalized hole diameter d/2a and a grating period (μm) relating to the coated optical fiber identifying apparatus according to the first embodiment of the present invention;

FIG. 7 is a diagram showing a relation between a refractive index changing amount and a stress applied location by the grating forming tool provided in the coated optical fiber identifying apparatus according to the first embodiment of the present invention;

FIG. 8 is a graph showing a relation between a normalized hole position c/2a and a grating period (μm) in HAF relating to the coated optical fiber identifying apparatus according to the first embodiment of the present invention;

FIG. 9A is a plan view for explaining another example of a grating forming tool provided in the coated optical fiber identifying apparatus according to the first embodiment of the present invention;

FIG. 9B is a side view for explaining another example of the grating forming tool provided in the coated optical fiber identifying apparatus according to the first embodiment of the present invention;

FIG. 9C is a diagram showing a relation between an optical fiber position and a refractive index changing amount when a mounting angle of the optical fiber is zero degrees in another example of the grating forming tool provided in the coated optical fiber identifying apparatus according to the first embodiment of the present invention;

FIG. 9D is a diagram showing a relation between an optical fiber position and a refractive index changing amount when a mounting angle of the optical fiber is θ in another example of the grating forming tool provided in the coated optical fiber identifying apparatus according to the first embodiment of the present invention;

FIG. 9E is a flow chart for conducting coated optical fiber identification using another example of the grating forming tool provided in the coated optical fiber identifying apparatus according to the first embodiment of the present invention;

FIG. 10 is a graph showing a relation between a wavelength and a loss spectrum by another example of the grating forming tool provided in the coated optical fiber identifying apparatus according to the first embodiment of the present invention;

FIG. 11 is a graph showing a relation between a force F and leak light power when grating formed by the coated optical fiber identifying apparatus according to the first embodiment of the present invention;

FIG. 12A is a diagram showing a case having one optical fiber bend applying mechanism in a coated optical fiber identifying apparatus according to a second embodiment of the present invention;

FIG. 12B is a diagram showing a case having two optical fiber bend applying mechanisms in the coated optical fiber identifying apparatus according to the second embodiment of the present invention;

FIG. 12C is a flow chart for conducing coated optical fiber identification using the coated optical fiber identifying apparatus according to the second embodiment of the present invention;

FIG. 13A is a diagram showing a relation between a bending radius (mm) and a bending loss (dB) in the optical fiber bend applying mechanism provided in the coated optical fiber identifying apparatus according to the second embodiment of the present invention;

FIG. 13B is a diagram showing a relation between a bending radius (mm) and leak light power (dBm) in the optical fiber bend applying mechanism provided in the coated optical fiber identifying apparatus according to the second embodiment of the present invention;

FIG. 14 is a diagram schematically showing a coated optical fiber identifying apparatus according to a third embodiment of the present invention; and

FIG. 15 is a graph showing leak light power and an insertion loss when grating formed in the coated optical fiber identifying apparatus according to the third embodiment of the present invention.

### DESCRIPTION OF EMBODIMENTS

Hereinafter, the embodiments of a coated optical fiber identifying apparatus according to the present invention will be explained in detail with reference to various embodiments.

### First Embodiment

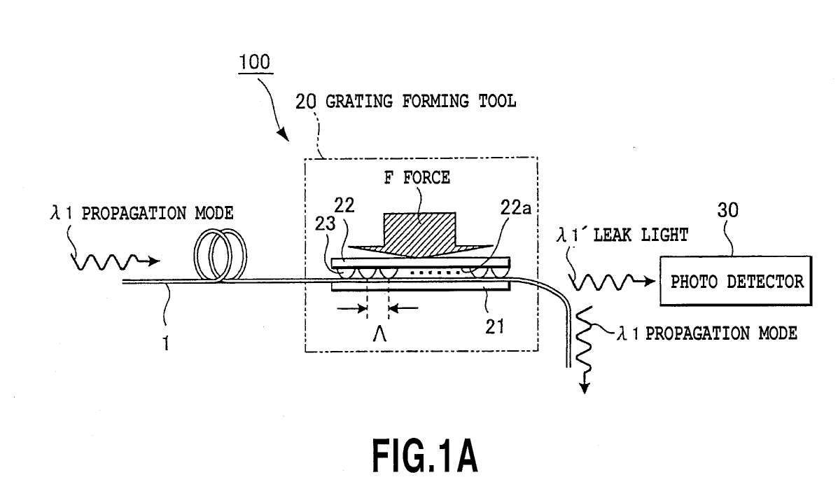

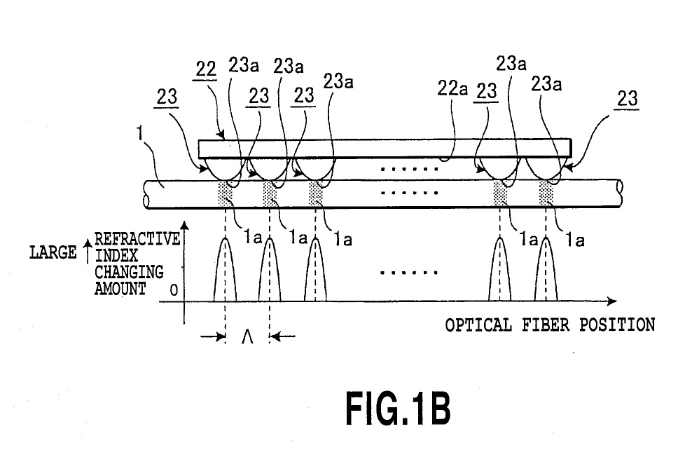

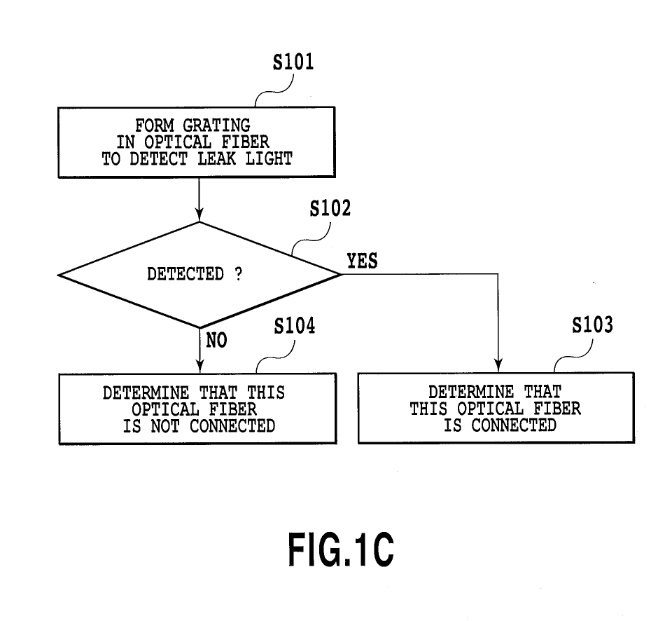

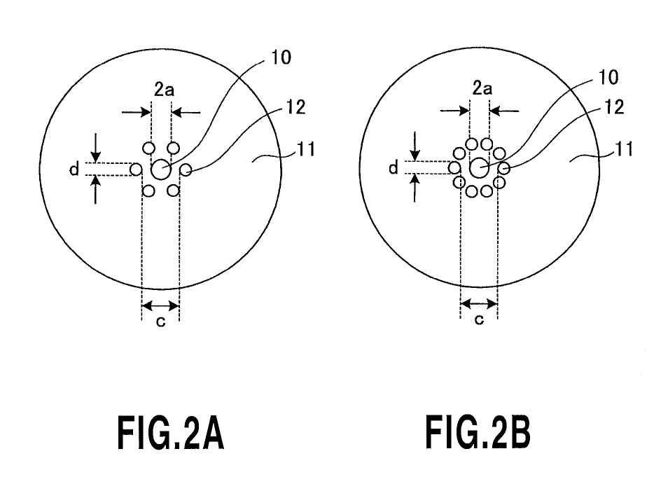

A first embodiment of a coated optical fiber identifying apparatus and a coated optical fiber identifying method according to the present invention will be explained with reference to FIG. 1A to FIG. 1C, FIG. 2A and FIG. 2B. In this embodiment, a case will be explained where the present embodiment is applied to an optical fiber having improved bending loss characteristics.

FIG. 1A and FIG. 1B are diagrams for explaining the coated optical fiber identifying apparatus according to the first embodiment in the present invention, where FIG. 1A shows an overview and FIG. 1B shows a relation between a refractive index changing amount and a stress applied location by a grating forming tool provided therein. It should be noted that in FIG. 1A, λ1 shows a propagation mode propagating in the optical fiber and λ1′ shows leak light leaked from the optical fiber.

The coated optical fiber identifying apparatus 100 according to the present embodiment, as shown in FIG. 1A, comprises a grating forming tool 20 (grating forming means), a photo detector 30 (photo reception means), etc.

The photo detector 30 is a device for detecting leak light generated in the optical fiber 1.

The grating forming tool 20 is a device for forming a grating by applying a force F to the optical fiber 1 with a plurality of protrusions 23 (concave and convex portions). Specifically, the grating forming tool 20 includes an optical fiber fixing tool 21, a stress applying tool 22, the protrusions 23, etc.

The optical fiber fixing tool 21 is a device capable of fixing the optical fiber 1 unmovable in an axial direction as well as in a circumferential direction. An example of the optical fiber fixing tool 21 includes a fixed base formed with a V groove on the upper surface and a pressing plate for pressing and fixing the optical fiber placed in the groove on the fixed base.

The stress applying tool 22 is a bar-shaped or plate-shaped device and is provided with the plurality of the protrusions 23 disposed on a lower surface 22a of this device. The plurality of the protrusions 23 are arranged such that a distance between tipping ends of the adjacent protrusions 23 is in accordance with a predetermined period Λ.

If the optical fiber 1 is an optical fiber excellent in bending loss characteristics, such as a single mode optical fiber with holes (HAF), no loss occurs even when the bending is applied to the optical fiber 1 without applying the force F shown in FIG. 1A, and therefore the photo detector 30 can not detect the leak light. In this case, when the force F is applied in the grating forming tool 20, a refractive index change occurs in predetermined locations 1a of the optical fiber 1 contacting with the tipping ends 23a of the protrusions 23, as shown in FIG. 1B. Since the tipping ends 23a of the plurality of the protrusions 23 are arranged in accordance with the predetermined period Λ, a long period grating is formed in which the refractive index change occurs in the period Λ. In the long period grating, when the period Λ and a wavelength λ of the light wave satisfy a phase matching condition expressed in the following formula (1), a propagation mode is converted into a higher order mode. In the following formula (1), nₒ denotes an effective refractive index of a propagation mode and nₘ denotes an effective refractive index of the higher order mode.

Λ=λ/(nₒ−nₘ) (1)

The higher order mode generated by the conversion has large propagation loss and bending loss compared with those in the propagation mode. Therefore, by the grating forming tool 20 converting a part of the propagation mode into the higher order mode and the photo detector 30 detecting the leaked higher order mode, the coated optical fiber identification can be realized for the optical fiber excellent in the bending loss characteristics, such as HAF. In other words, by applying the force F to the optical fiber 1 with the plurality of the protrusions 23 arranged in accordance with the predetermined period Λ to form the long period grating with the period Λ in the optical fiber 1, and the photo detector 30 detecting the resulting leak light λ1′, it is possible to determine that the light wave is propagated in the optical fiber 1.

FIG. 1C shows a flow chart for conducting the coated optical fiber identification using the coated optical fiber identifying apparatus according to the first embodiment of the present invention. First, in the coated optical fiber identifying apparatus, a force is applied to the grating forming tool to detect leak light (S101). At this time, when the leak light is detected (S102), it is determined that this optical fiber is connected (S103). When the leak light is not detected (S102), it is determined that this optical fiber is not connected (S104).

FIG. 2A and FIG. 2B each show an example of a HAF structure for the coated optical fiber identification in the present invention. An example of HAF includes, as shown in FIG. 2A, a single mode optical fiber with holes comprising a core portion 10, a clad portion 11 covering the circumference thereof, and six holes 12 provided at a predetermined distance from the core portion, wherein a normalized hole position is c/2a and a normalized hole diameter is d/2a or, as shown in FIG. 2B, a single mode optical fiber with holes comprising the core portion 10, the clad portion 11 covering the circumference thereof, and ten holes 12 provided at a predetermined distance from the core portion, wherein the normalized hole position is c/2a and the normalized hole diameter is d/2a. As shown in Patent Literature 1, HAF includes the core, the clad, and the plurality of the holes, and for realizing the excellent bending loss characteristics by the confinement effect of the holes and excellent connectivity with the conventional single mode fiber (SMF), it is required that the core diameter 2a is within a range of 6.4 μm to 9.6 μm, the relative refractive index difference Λ to the clad of the core is from 0.3% to 0.55%, and the normalized hole position c/2a is in a range of 2.0 to 4.5, and the normalized hole diameter d/2a is 0.2 or more.

[Relation Between Protrusion Period and Loss]

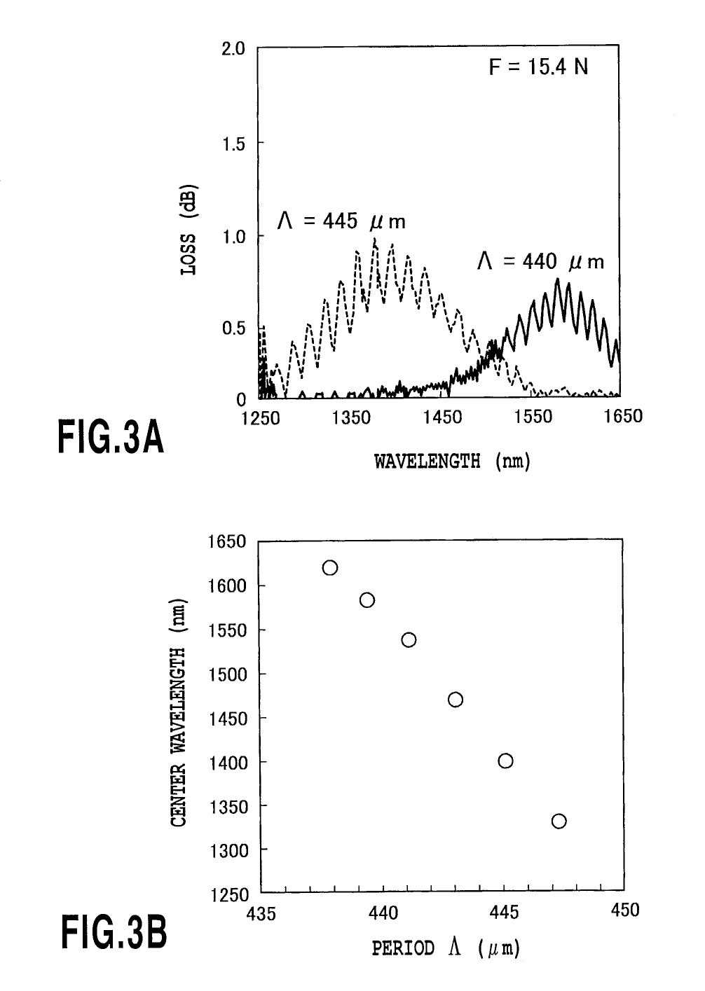

A relation between a protrusion period and a loss will now be explained with reference to FIG. 3A and FIG. 3B.

FIG. 3A and FIG. 3B are diagrams for explaining a relation between a protrusion period and a loss. FIG. 3A shows a relation between a wavelength and a loss spectrum when the force F is 15.4N and the protrusion period is 440 μm and 445 μm, and FIG. 3B shows a relation between a protrusion period and a center wavelength (wavelength where the loss spectrum is maximized). In this case, the optical fiber is a HAF where a core diameter 2a=9 μm, a relative refractive index difference Δ=0.35%, a normalized hole position c/2a=2.0, a normalized hole diameter d/2a=1.0, and the number of holes is six. In FIG. 3A, a solid line shows a case where the protrusion period Λ is 440 μm and a dotted line shows a case where the protrusion period Λ is 445 μm.

As shown in FIG. 3A, it is understood from the loss spectrum that an optical loss occurs at a predetermined wavelength by forming a grating. In addition, as shown in FIG. 3B, it is understood that when the protrusion period Λ is made large, inversely proportional to it, the center wavelength becomes small. Thus, it is understood that the loss occurring wavelength can be controlled by changing the period Λ based on the period dependency of the center wavelength. From these, it is understood that the optical loss can be obtained at the desired wavelength by designing the grating period appropriately.

[Relation Between Hole Structure of HAF (Distance c Between Holes Opposing Around the Core Portion) and Grating Period]

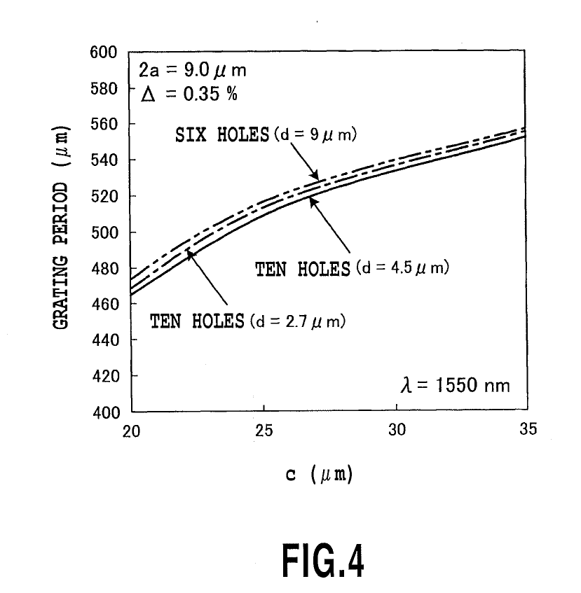

An example of a relation between a hole structure of HAF and a grating period will now be explained with reference to FIG. 4.

FIG. 4 is a graph showing an example of hole structure dependency of the grating period in HAF relating to the coated optical fiber identifying apparatus in accordance with the first embodiment of the present invention. In this case, the wavelength for the coated optical fiber identification is 1550 nm and the core structure of HAF has a core diameter 2a of 9 μm and a relative refractive index difference Λ of 0.35%. In FIG. 4, a solid line shows HAF having a hole diameter d of 4.5 μm and ten holes, a dashed-dotted line shows HAF having a hole diameter d of 2.7 μm and ten holes, and a dashed-two dotted line shows HAF having a hole diameter d of 9 μm and six holes.

As shown in FIG. 4, it is understood that in HAF, as the hole positions are farther away (are spaced farther) from each other, the grating period monotonically increases. This can be understood such that as the holes are farther away from each other, an effect of the holes on the light wave becomes smaller, which becomes closer to the grating period of SMF. Also when the hole becomes smaller or when the number of holes is less, the grating period becomes larger by the same principle. In addition, one can readily assume that this relationship is similar to the other core structure.

[Relation Between Core Structure of HAF (Core Diameter 2a or Relative Refractive Index Difference Λ) and Grating Period]

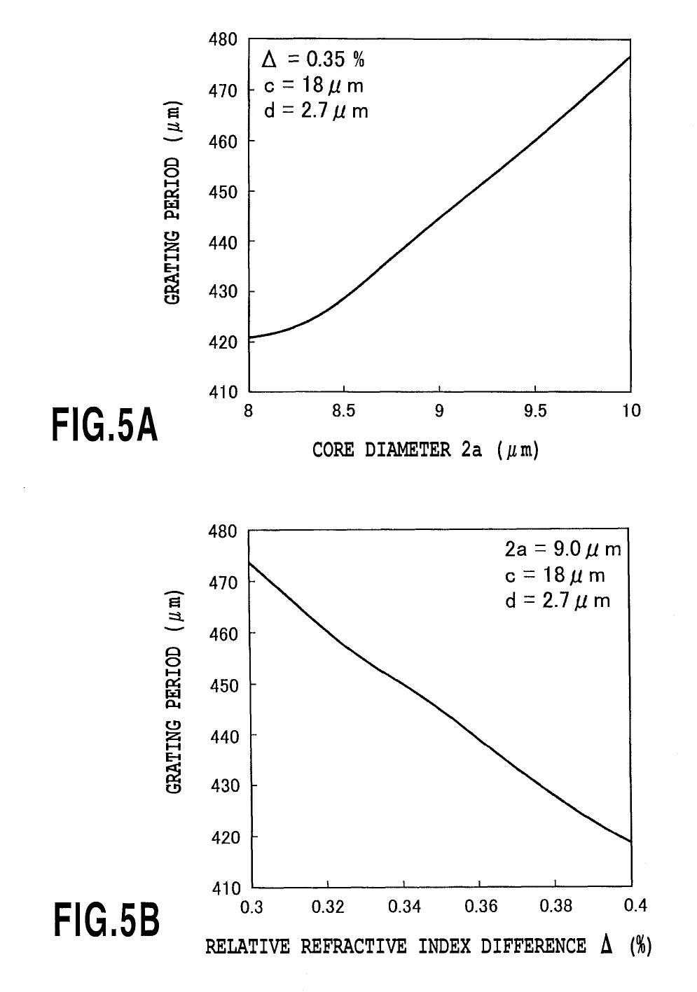

FIG. 5A and FIG. 5B are graphs each showing core structure dependency of a grating period in HAF relating to the coated optical fiber identifying apparatus according to the first embodiment of the present invention. FIG. 5A shows a relation between a core diameter 2a (μm) and a grating period (μm) and FIG. 5B shows a relation between a relative refractive index difference Δ(%) and a grating period (μm). In this case, the hole structure of HAF is such that a distance c between holes opposing around the core portion is 18 μm, a hole diameter d is 2.7 μm, and the number of holes is 10.

As shown in FIG. 5A and FIG. 5B, it is understood that when the core diameter 2a is large or when the relative refractive index difference Δ is small, the grating period becomes large.

By combining these conditions with the requirements of HAF described in Patent Literature 1, it is understood from FIG. 4 that with respect to the hole structure, the grating period is minimized when the holes are the nearest, c/2a=2.0, and the grating period is maximized when the holes are the farthest and the hole diameter is the smallest, c/2a=4.5 and d/2a=0.2. In addition, it is understood from FIG. 5A and FIG. 5B that with respect to the core structure, the grating period is minimized when the core is the smallest and the relative refractive index difference is the largest, 2a=6.4 μm and Λ=0.55%, and the grating period is maximized when the core is the largest and the relative refractive index difference is the smallest, 2a=9.6 μm and Λ=0.3%. In addition, since the core structure and the hole structure are designed under these conditions, one can easily understand that the grating period also linearly changes between values of these structures.

[Period of Protrusions]

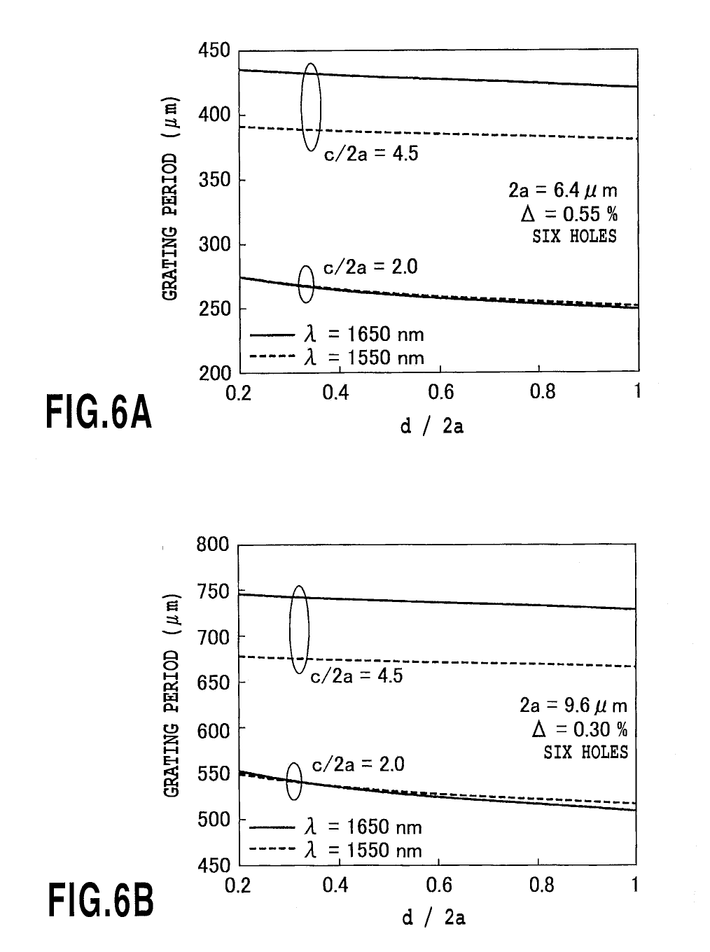

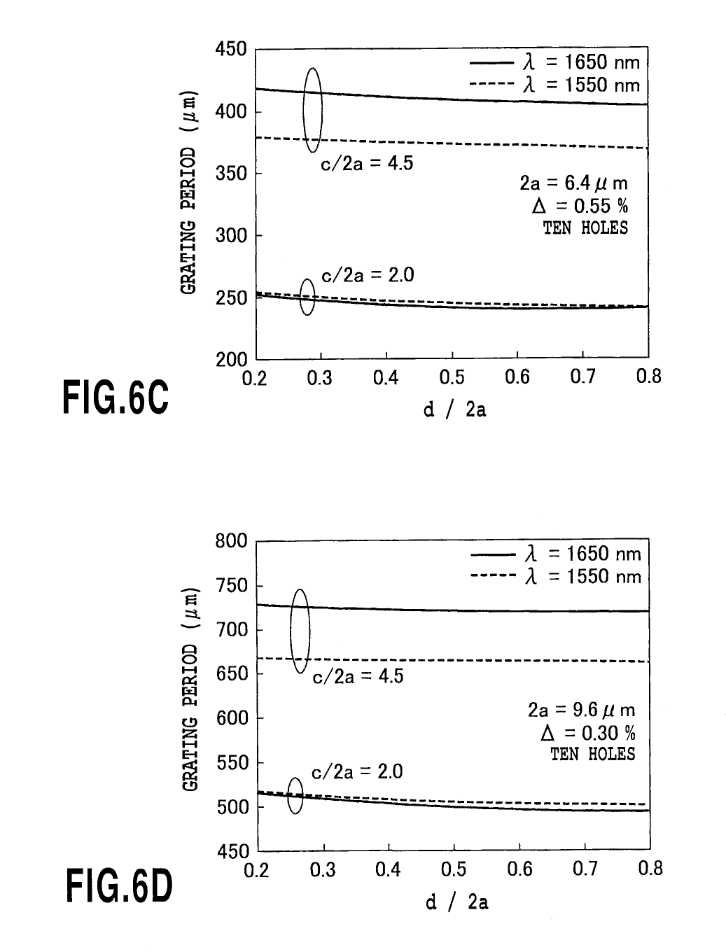

The period of the protrusions will now be explained with reference to FIG. 6A to FIG. 6D.

FIG. 6A to FIG. 6D are graphs each showing a relation between a normalized hole diameter d/2a and a grating period (μm). FIG. 6A shows a case of a single mode optical fiber with holes having a core diameter 2a of 6.4 μm, a relative refractive index difference Λ of 0.55% and six holes. FIG. 6B shows a case of a single mode optical fiber with holes having a core diameter 2a of 9.6 μm, a relative refractive index difference Λ of 0.30% and six holes. FIG. 6C shows a case of a single mode optical fiber with holes having a core diameter 2a of 6.4 μm, a relative refractive index difference Λ of 0.55% and ten holes. FIG. 6D shows a case of a single mode optical fiber with holes having a core diameter 2a of 9.6 μm, a relative refractive index difference Λ of 0.30% and ten holes. FIG. 6A to FIG. 6D show a case where the normalized hole position c/2a is 2.0 or 4.5 and the wavelength λ often used as test light is set as 1550 nm and 1650 nm.

As shown in FIG. 6A to FIG. 6D, it is understood that the grating period becomes minimum of 0.24 mm when the core diameter 2a is 6.4 μm, the relative refractive index difference Λ is 0.55% and the normalized hole position c/2a is 2.0, and the grating period becomes maximum of 0.75 mm when the core diameter 2a is 9.6 μm, the relative refractive index difference Λ is 0.3% and the normalized hole position c/2a is 4.5. Accordingly, it is understood that for realizing the coated optical fiber identification of the present invention for HAF, it is required that the protrusion period is within a range of 0.24 mm to 0.75 mm.

[Example of Grating Forming Tool]

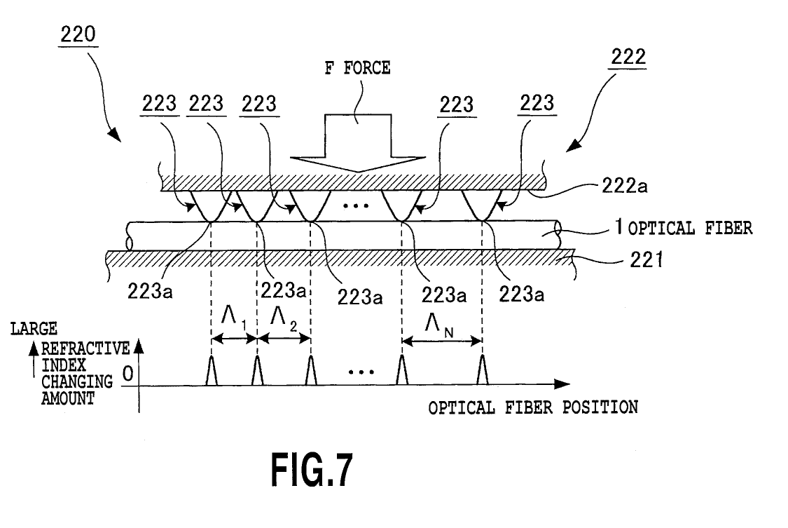

An example of a grating forming tool provided in the coated optical fiber identifying apparatus according to the first embodiment of the present invention mentioned above will now be explained with reference to FIG. 7.

FIG. 7 is a schematic diagram showing an example of the grating forming tool provided in the coated optical fiber identifying apparatus according to the first embodiment of the present invention.

As shown in FIG. 7, in a grating forming tool 220, a plurality of protrusions 223 are provided on a lower surface portion 222a of a stress applying tool 222. A period of the plurality of the protrusions 223 (a distance between tipping ends 223a of the adjacent protrusions 223) changes in a longitudinal direction of the optical fiber 1. Specifically, the period between the tipping ends 223a of the plurality of the protrusions 223 adjacent at the left end of the figure is at Λ1. On the other hand, the period between the tipping ends 223a of the plurality of the protrusions 223 adjacent to the left end of the figure is at Λ2 (>Λ1). The period between the adjacent tipping ends 223a of the plurality of the protrusions 223 gradually increases from Λ1 at the left end toward from the left side to the right side in the figure and reaches ΛN at the right end. In other words, the period Λ of the plurality of the protrusions 223 changes along the mounting direction of the optical fiber 1. At this time, suppose that the grating period changes from Λ1 to ΛN, the optical loss can be generated at all the operation wavelengths which satisfy phase matching conditions from Λ1 to ΛN. Thereby, a plurality of the periods can be effectively realized simultaneously. As mentioned above, the grating period required for HAF changes with the fiber structure. Since an optical fiber actually manufactured has a predetermined structural deviation, the grating period required for such HAF will vary. In this case, it is preferable that variations due to the structural deviation can be absorbed with the configuration in FIG. 7.

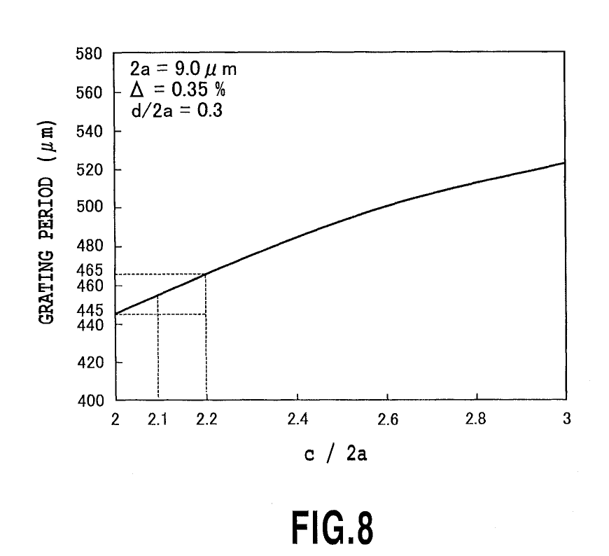

A relation between the normalized hole position c/2a and the grating period will now be explained with reference to FIG. 8.

FIG. 8 is a graph showing a relation between the grating period and the normalized hole position c/2a in HAF having the structure where the core diameter 2a is 9.0 μm, the relative refractive index difference Λ is 0.35%, and the normalized hole diameter d/2a is 0.3.

Considering a case where the normalized hole position c/2a of 2.1 is defined as an optimal structure and the structural deviation to the normalized hole position c/2a is ±0.1, the grating period, as shown in FIG. 8, varies from 445 μm to 465 μm. Thus, it is understood that the protrusions may be placed such that the protrusion period gradually changes from 445 μm to 465 μm.

In consequence, by changing the period of the protrusions 223 within a range of 0.24 mm to 0.75 mm, the coated optical fiber identification of the single mode optical fiber with holes (HAF) having various types of core structures and hole structures can be reliably conducted.

[Another Example of Grating Forming Tool]

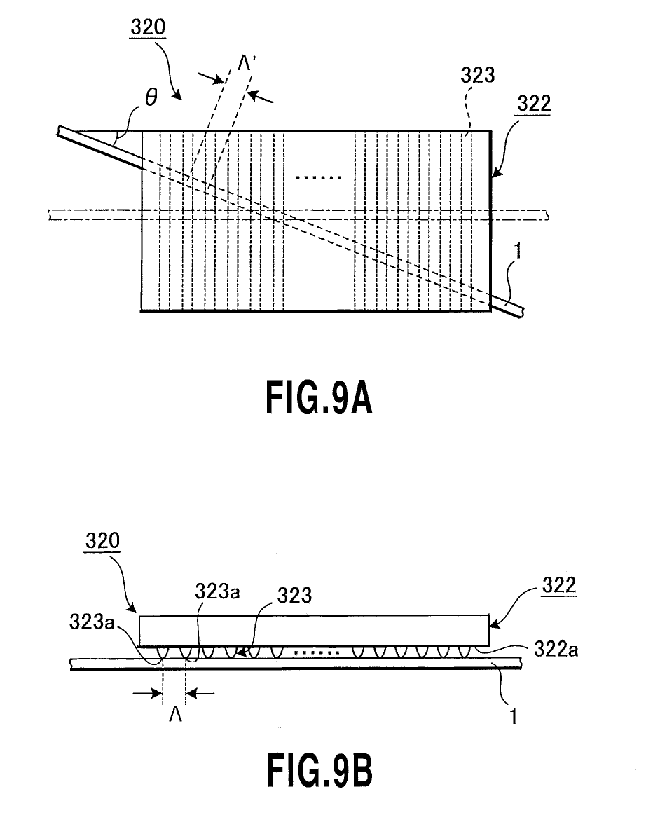

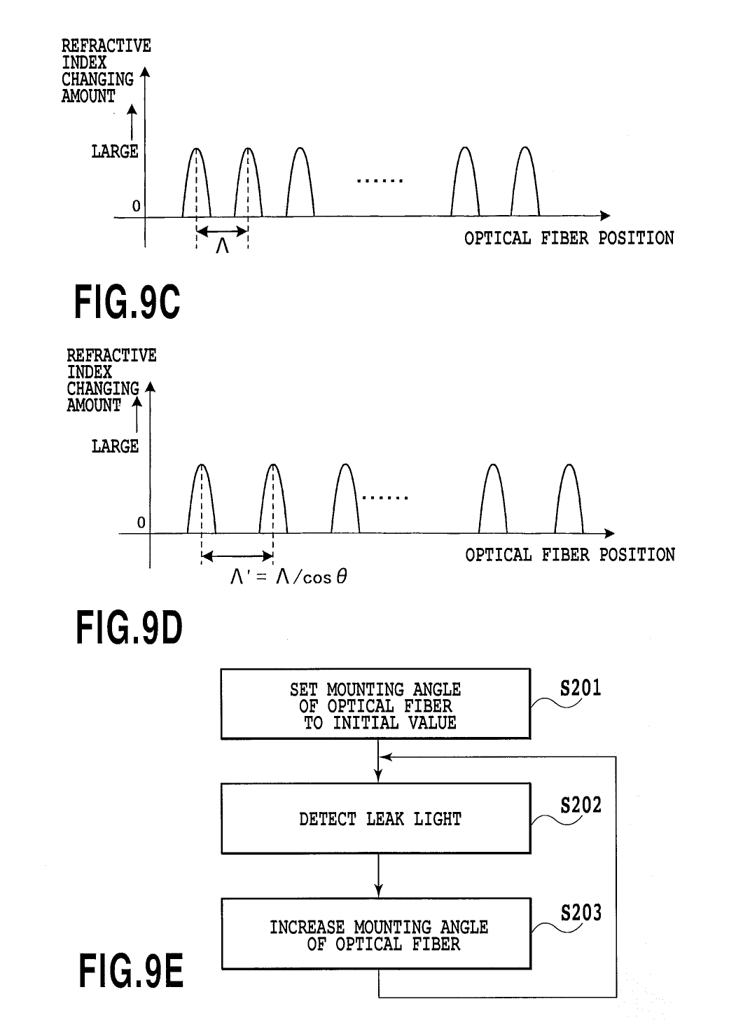

Another example of a grating forming tool provided in the coated optical fiber identifying apparatus according to the first embodiment of the present invention mentioned above will now be explained with reference to FIG. 9A to FIG. 9D.

FIG. 9A to FIG. 9D are diagrams for explaining another example of the grating forming tool provided in the coated optical fiber identifying apparatus according to the first embodiment of the present invention. FIG. 9A shows the plan view, FIG. 9B shows the side view, FIG. 9C shows a relation between an optical fiber position and a refractive index changing amount when a mounting angle of the optical fiber is zero degrees, and FIG. 9D shows a relation between an optical fiber position and a refractive index changing amount when a mounting angle of the optical fiber is θ.

As shown in FIG. 9A and FIG. 9B, a grating forming tool 320 includes a stress applying tool 322 in a substantially rectangular parallelepiped shape. A plurality of protrusions 323 are provided on a lower surface portion 322a of the stress applying tool 322. The plurality of the protrusions 323 are arranged in a predetermined period Λ along a longer direction of the stress applying tool 322. In this case, when the mounting direction of the optical fiber 1 is set at zero degrees with respect to the longer direction of the stress applying tool 322 (arrangement direction of the plurality of the protrusions 323), as shown in FIG. 9C, a force is applied to the optical fiber 1 at a predetermined period Λ with the plurality of the protrusions 323. On the other hand, when the mounting angle of the optical fiber 1 is set at θ with respect to the longer direction of the stress applying tool 322 (arrangement direction of the plurality of the protrusions 323), as shown in FIG. 9D, a force is applied to the optical fiber 1 at a predetermined period Λ′ (=Λ/cos θ) with the plurality of the protrusions 323. Thus, by changing the mounting angle θ of the optical fiber 1, an effective grating period can be changed.

FIG. 9E shows a flow chart for conducting coated optical fiber identification using another example of the grating forming tool provided in the coated optical fiber identifying apparatus according to the first embodiment of the present invention. First, the optical fiber is placed in the coated optical fiber identifying apparatus so as to set the mounting angle θ to an initial value (S201). Next, leak light from the optical fiber is detected by the coated optical fiber identifying apparatus (S202). Thereafter, detection of the leak light is repeated while increasing the mounting angle of the optical fiber until sufficient leak light is detected (S203).

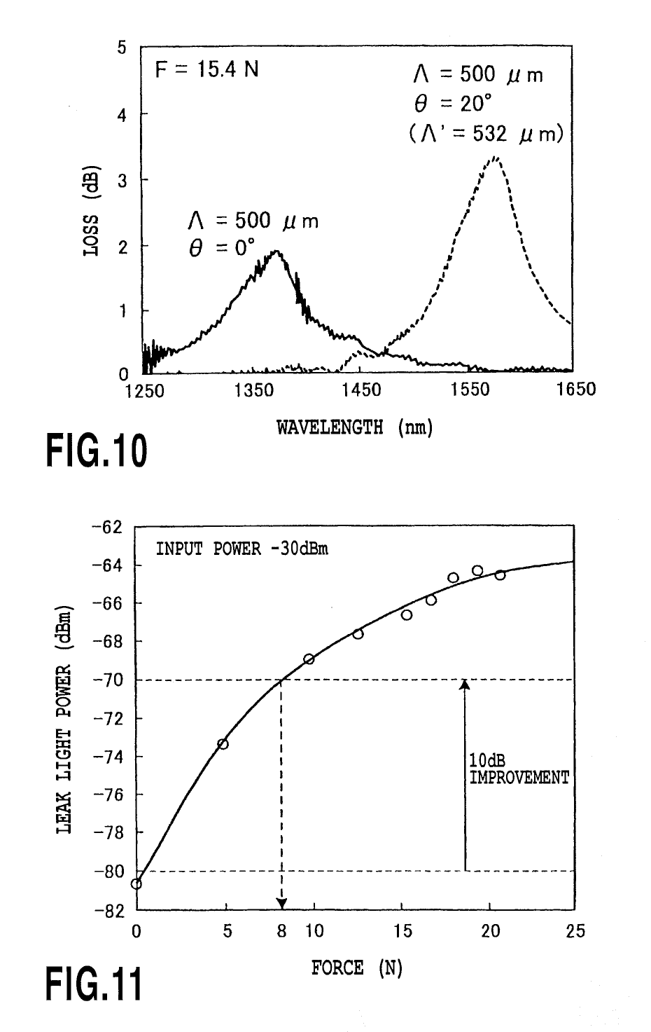

A relation between the wavelength and the loss will now be explained with reference to FIG. 10.

FIG. 10 is a graph showing a relation between the wavelength and the loss spectrum by the grating forming tool. Now, in FIG. 10, the optical fiber is HAF in which the number of holes is ten and a mode field diameter and a bending loss at the wavelength of 1550 nm are 10.5 μm and 0.1 dB/turn (bending radius of 5 mm) or less, respectively. A force F applied to the stress applying tool is 15.4N and a period Λ of the plurality of the protrusions provided in the stress applying tool is 500 μm. In FIG. 10, a solid line shows a case when the mounting angle θ of the optical fiber is zero degrees and a dotted line shows a case when the mounting angle θ of the optical fiber is 20 degrees.

As shown in FIG. 10, when the period Λ of the protrusions is 500 μm and the mounting angle θ of the optical fiber with respect to the arrangement direction of the plurality of the protrusions is zero degrees, it is understood that the loss spectrum is maximized at the wavelength of about 1360 nm. In addition, when the period Λ of the protrusions is 500 μm and the mounting angle θ of the optical fiber with respect to the arrangement direction of the plurality of the protrusions is 20 degrees, it is the same as a case when the period Λ′ of the protrusions is 532 μm, and it is understood that the loss spectrum is maximized at the wavelength of about 1560 nm. Thus, by using the grating forming tool provided with the plurality of the protrusions arranged with the lower limit period (Λmin) within the desired range, the effective grating period can be changed. In other words, when an angle of the optical fiber mounted in a direction vertical to the arrangement direction of the plurality of the protrusions is assumed to be zero degree, since the effective grating period when inclining the mounting angle of the optical fiber by θ is Λmin/cos θ, the effective grating period can be changed by changing the mounting angle θ of the optical fiber. Therefore, an efficiency of the operation can be attained.

Accordingly, by arranging the optical fiber so as to change the mounting angle θ of the optical fiber with respect to the arrangement direction of the plurality of the protrusions and changing the effective grating period within a range of 0.24 mm to 0.75 mm, the coated optical fiber identification can be reliably conducted for the single mode optical fiber with holes (HAF) having various types of core structures and hole structures.

[Relation Between Force and Leak Light Power]

A relation between a force and leak light power will now be explained with reference to FIG. 11.

FIG. 11 is a graph showing a relation between a force F and leak light power when grating formed by the coated optical fiber identifying apparatus according to the first embodiment of the present invention. In this case, the grating formed range is a total length of 4 cm (the number of the protrusions is 88), and HAF is used as the optical fiber having a core diameter 2a of 9 μm, a relative refractive index difference Λ of 0.35%, a normalized hole position c/2a of 2.0, and a normalized hole diameter d/2a of 0.3. Further, input light power is at 30 dBm. The minimum photo sensitivity of the photo detector is at −80 dBm.

As shown in FIG. 11, it is understood that when the force is not applied (the present invention is not applied), the leak light can not be detected by the photo detector. In addition, it can be confirmed that the function of the grating can be enhanced by increasing the force, thereby realizing the coated optical fiber identification with increased leak light power. Further, it is preferable that by increasing a total force to the all the protrusions to 8N or more (the force per one protrusion is 0.09N or more) in the grating forming tool, the leak light power can be improved by 10 dB.

It should be noted that since the force per unit length increases even if the total length of the grating forming tool, which forms the grating, is shortened to less than 4 cm, the similar leak light power can be obtained with the same force applied. Accordingly, regardless of the total length of the grating forming tool, by increasing the force applied to the grating forming tool to more than 8N, the coated optical fiber identification can be realized.

### Second Embodiment

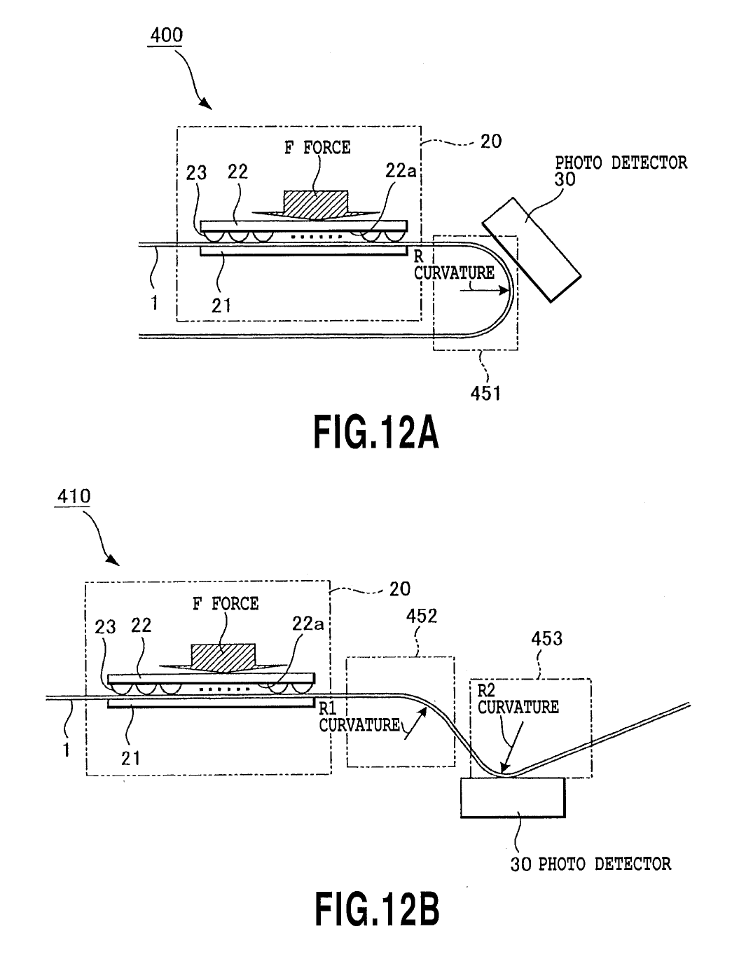

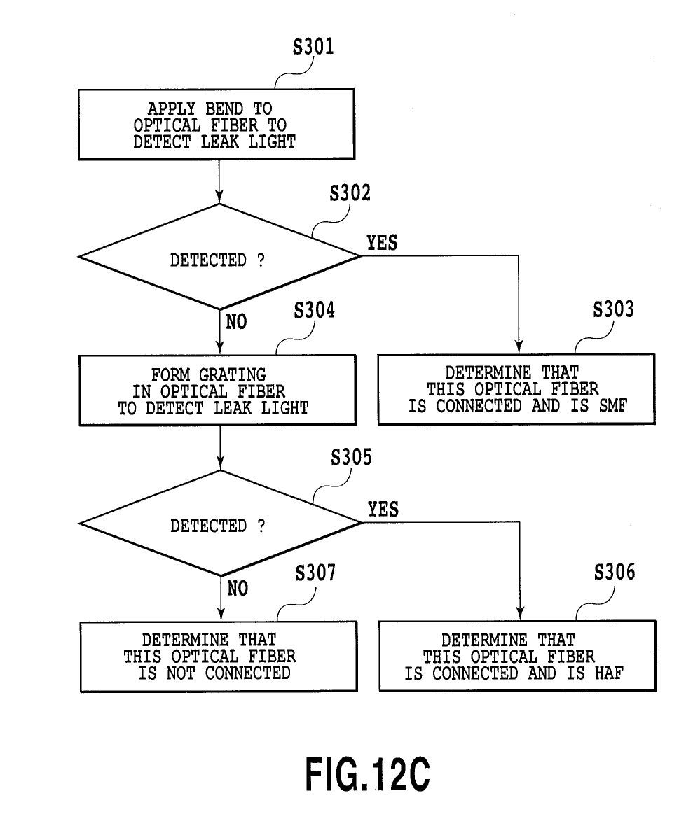

A coated optical fiber identifying apparatus according to a second embodiment of the present invention will be explained with reference to FIG. 12A and FIG. 12B.

FIG. 12A and FIG. 12B are diagrams for explaining the coated optical fiber identifying apparatus according to the second embodiment of the present invention. FIG. 12A shows a case where a single optical fiber bend applying mechanism is provided and FIG. 12B shows a case where two optical fiber bend applying mechanisms are provided.

The present embodiment is an apparatus in which the optical fiber bend applying mechanism is added to the coated optical fiber identifying apparatus according to the first embodiment of the present invention.

In the present embodiment, the same devices as those in the coated optical fiber identifying apparatus according to the aforementioned first embodiment are assigned with same numerals, omitting the explanation.

A coated optical fiber identifying apparatus 400 according to the present embodiment, as shown in FIG. 12A, includes an optical fiber bend applying mechanism 451 (optical fiber bend applying means) for applying bend to the optical fiber 1, the grating forming tool 20, the photo detector 30, etc. The optical fiber bend applying mechanism 451 is a mechanism capable of holding the optical fiber 1 with one turn having a predetermined curvature radius R. The optical fiber bend applying mechanism 451 is placed immediately before the photo detector 30. In other words, the optical fiber bend applying mechanism 451 is placed close to the photo detector 30. In this way, a photo reception efficiency at the photo detector 30 is improved. Specifically, since a higher order mode generated by the grating has a larger bending loss as compared to that of the propagation mode, the higher order mode can be efficiently leaked due to presence of the optical fiber bend applying mechanism 451 close to the photo detector 30. In addition, having the optical fiber bend applying mechanism 451, it is possible to detect a bending loss for the optical fiber having a regular bending loss such as SMF, and at the same time, it is possible to realize the coated optical fiber identifications for HAF and SMF simultaneously by a single apparatus, which is preferable.

In addition, as shown in FIG. 12B, a coated optical fiber identifying apparatus 410 may be configured comprising the grating forming tool 20, the photo detector 30, optical fiber bend applying mechanisms 452 and 453, etc. The optical fiber bend applying mechanism 452 is a mechanism capable of holding the optical fiber 1 with one turn having a first curvature radius R1. The optical fiber bend applying mechanism 453 is a mechanism capable of holding the optical fiber 1 with one turn having a second curvature radius R2 different from the first curvature radius R1. Even in the coated optical fiber identifying apparatus 410 with such configuration, similar effect to that of the aforementioned coated optical fiber identifying apparatus 400 is obtained.

It should be noted that a coated optical fiber identifying apparatus may be configured comprising two optical fiber bend applying mechanisms which can hold the optical fiber with the same curvature radius. A coated optical fiber identifying apparatus may be configured comprising three or more optical fiber bend applying mechanisms. A coated optical fiber identifying apparatus may be configured by placing the optical fiber bend applying mechanism within the photo detector. Even in such coated optical fiber identifying apparatuses, similar effect to that of the coated optical fiber identifying apparatus of the second embodiment mentioned above is obtained.

FIG. 12C shows a flow chart for conducting coated optical fiber identification using the coated optical fiber identifying apparatus according to the second embodiment of the present invention. First, in the coated optical fiber identifying apparatus, a predetermined bend is applied to the optical fiber to detect leak light (S301). At this time, when the leak light is detected without applying a force to the grating forming tool of the coated optical fiber identifying apparatus (S302), it is determined that this optical fiber is connected and is SMF (S303). Next, the leak light is detected by applying a force to the grating forming tool in the coated optical fiber identifying apparatus (S304). At this time, when the leak light is detected (S305), it is determined that this optical fiber is connected and is HAF (S306). When the leak light is not detected (S305), it is determined that this optical fiber is not connected (S307).

[Relation Between Bending Radius and Bending Loss]

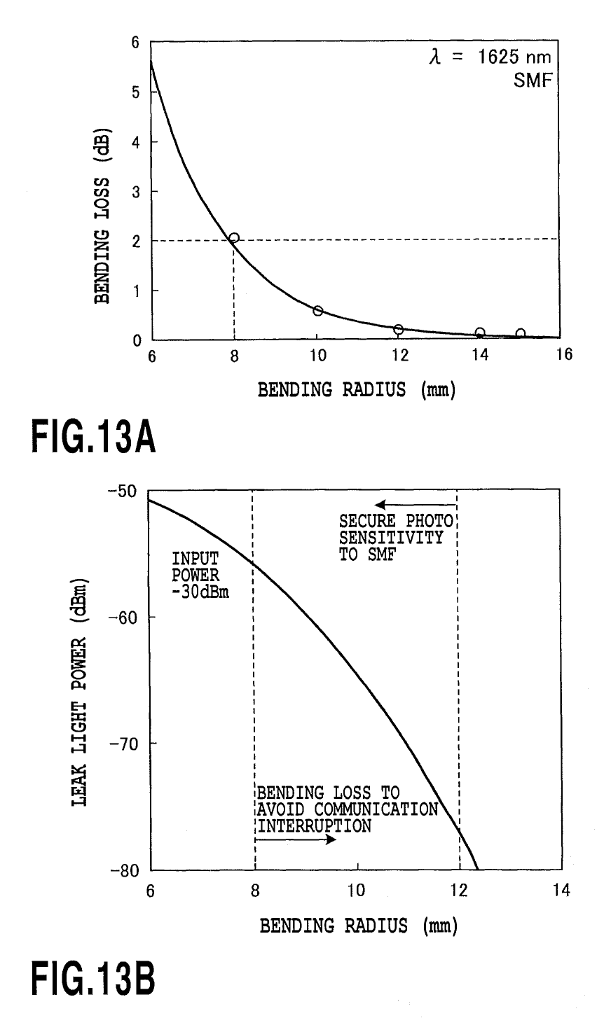

A relation between a bending radius and a bending loss in the optical fiber bend applying mechanism provided in the coated optical fiber identifying apparatus according to the second embodiment mentioned above will now be explained with reference to FIG. 13A and FIG. 13B.

FIG. 13A and FIG. 13B are graphs showing optical characteristics in the optical fiber bend applying mechanism provided in the coated optical fiber identifying apparatus according to the second embodiment in the present invention. FIG. 13A shows a relation between a bending radius (mm) and a bending loss (dB). FIG. 13B shows a relation between a bending radius and leak light power (dBm). In other words, FIG. 13A and FIG. 13B show an insertion loss and detectable leak light power to a bending radius of the optical fiber bend applying mechanism according to the coated optical fiber identifying apparatus in the present embodiment. Since it can not always be determined whether or not the optical fiber under the coated optical fiber identification is a strong optical fiber to bending, when an abrupt bend is applied to SMF, an excessive loss may occur and communications may be cut, for example.

FIG. 13A shows a bending loss at the longest wavelength of 1625 nm in the communication wavelength band in SMF as the weakest condition to the bending. It is preferable that the bending loss can be equal to or less than 2 dB by setting the bending radius to 8 mm or more as shown in FIG. 13A.

In addition, FIG. 13B shows leak light power and a bending radius when detecting a bending loss in SMF. As shown in FIG. 13B, it is preferable that by setting the bending radius to 12 mm or less, the coated optical fiber identification by the bending can be realized for SMF and as shown in FIG. 12A and FIG. 12B, the coated optical fiber identification can be simultaneously conducted for HAF and SMF. From these, it is understood that the bending radius is preferably within a range of 8 mm to 12 mm.

### Third Embodiment

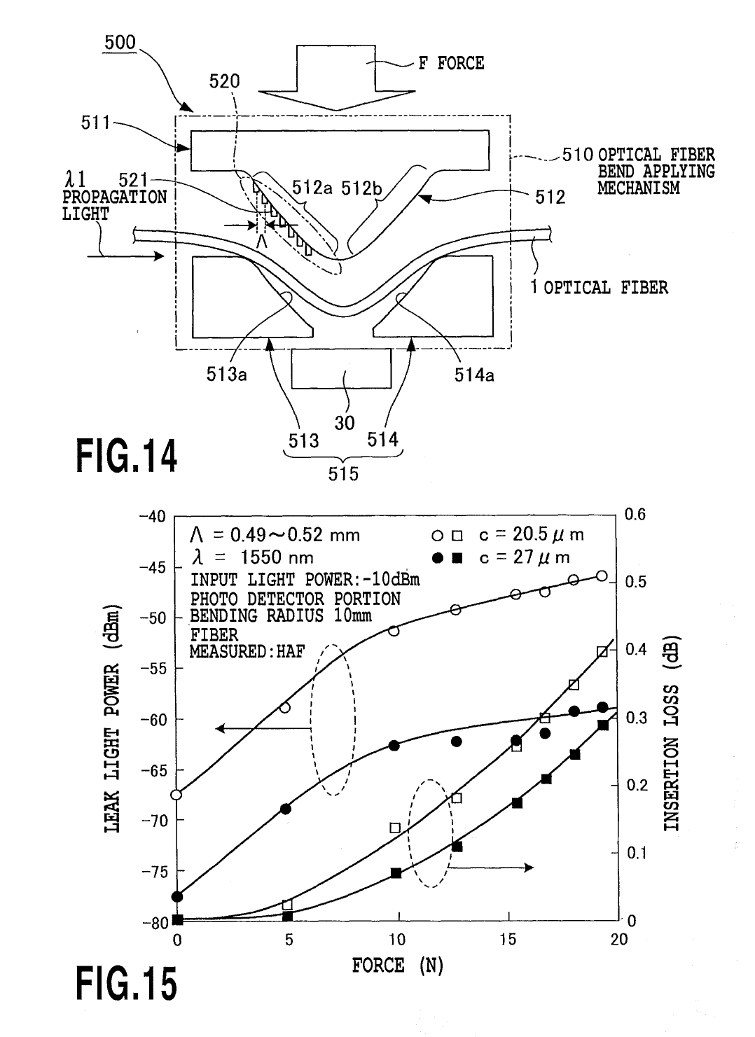

A coated optical fiber identifying apparatus according to a third embodiment of the present invention will now be explained with reference to FIG. 14.

FIG. 14 is a diagram schematically showing the coated optical fiber identifying apparatus according to the third embodiment of the present invention.

The coated optical fiber identifying apparatus according to the present embodiment is an apparatus comprising the grating forming tool and the optical fiber bend applying mechanism in the same device, which are provided in the coated optical fiber identifying apparatus according to the aforementioned second embodiment.

In the present embodiment, the same devices (photo detector 30) as those in the coated optical fiber identifying apparatus according to the aforementioned second embodiment are assigned with the same numerals, omitting the explanation.

A coated optical fiber identifying apparatus 500 according to the present embodiment, as shown in FIG. 14, comprises an optical fiber bend applying mechanism 510, a grating forming tool 520 (grating forming means), the photo detector 30, etc.

The optical fiber bend applying mechanism 510 is composed of a convex member 511 and a concave member 515. The convex member 511 comprises one convex portion formed in an arc shape and a curved portion 512 composed of two concave portions smoothly joined to both sides of the convex portion. The convex member 511 is slidably placed with respect to the concave member 515. The concave member 515 is composed of a first concave member 513 and a second concave member 514. The first concave member 513 and the second concave member 514 comprise a curved portion 513a and a curved portion 514a, respectively, and are formed in a shape capable of tightly holding the optical fiber with the curved portion 512.

The grating forming tool 520 is composed of a plurality of protrusions 521 (concave and convex portions) provided in a inlet side curved portion 512a positioned at an inlet side in a propagation direction of light in the curved portion 512 of the convex member 511. In other words, the grating forming tool 520 is placed within the optical fiber bend applying mechanism 510. The plurality of the protrusions 521 are arranged with a predetermined period (interval) Λ. It should be noted that the plurality of the protrusions are not provided at an outlet side curved portion 512b positioned at an outlet side (right side in the figure) in a propagation direction of light in the curved portion 512 of the convex member 511.

Thus, according to the coated optical fiber identifying apparatus 500 of the present embodiment, it is preferable that the optical fiber bend applying mechanism 510 and the grating forming tool 520 can be unified to realize the coated optical fiber identifying apparatus which is compact in size and is excellent in workability.

[Relation Between Force, and Leak Light Power and Insertion Loss]

A relation between force, and leak light power and an insertion loss will now be explained with reference to FIG. 15.

FIG. 15 is a graph showing leak light power and an insertion loss when grating formed. In this case, two kinds of HAFs (HAF having a distance c between holes opposing around a core portion of 20.5 μm, and HAF having a distance c between holes opposing around a core portion of 27 μm) are used, as optical fibers to be measured. These HAFs have the bending loss of 0.01 dB/turn or less in the bending radius of 5 mm realizing the bending loss smaller than SMF by three digits or more. In addition, in an apparatus system, as shown in FIG. 7, the grating period is changed in a range of 0.49 mm to 0.52 mm in a mounting direction of the optical fiber (longitudinal direction of the optical fiber) and a force F to be applied is set from 0 to 20N. In addition, in the photo detector 30, the bend having a curvature radius of 10 mm is provided right before a photo-receiving element. The measurement wavelength and the input light power are set at 1550 nm and −10 dBm, respectively.

As shown in FIG. 15, by applying a force F to both HAFs, it can be confirmed that the leak light power can be improved by 10 dB or more. In addition, by changing the grating period in the longitudinal direction, it can be confirmed that the leak light power detections of HAFs having different hole structures can be achieved by single apparatus. In addition, the insertion loss when applying a force is as small as 0.4 dB or less in a measurement range and it is understood that at the low insertion loss, the leak light power is improved. Therefore, it is understood that the coated optical fiber identification for HAF excellent in bending loss characteristics can be realized using the coated optical fiber identifying apparatus according to the present invention.

### Other Embodiment

In the above, while it is described of the coated optical fiber identifying apparatus with the stress applying tool provided with the plurality of the protrusions, it is possible to adopt a coated optical fiber identifying apparatus with the plurality of the protrusions provided on the fixed base for fixing the optical fiber. Even with such coated optical fiber identifying apparatus, a similar effect to that of the coated optical fiber identifying apparatus according to the first, second and third embodiments is obtained.

### INDUSTRIAL APPLICABILITY

The coated optical fiber identifying apparatus and the coated optical fiber identifying method according to the present invention can be utilized to identify an optical fiber in the construction, maintenance and operation of the optical line.

1.-9. (canceled)

10. A coated optical fiber identifying apparatus comprising:
a grating forming means for forming a grating by applying a force to an optical fiber with a plurality of protrusions; and
a photo reception means for detecting leak light generated in the optical fiber.

11. A coated optical fiber identifying apparatus according to claim 10, wherein a period of the plurality of the protrusions changes along a mounting direction of the optical fiber.

12. A coated optical fiber identifying apparatus according to claim 10, wherein the force is 8N or more.

13. A coated optical fiber identifying apparatus according to claim 10, further comprising:
an optical fiber bend applying means for applying bending to the optical fiber, wherein a curvature radius of the bending is within a range of 8 mm to 12 mm.

14. A coated optical fiber identifying apparatus according to claim 11, further comprising:
an optical fiber bend applying means for applying bending to the optical fiber, wherein a curvature radius of the bending is within a range of 8 mm to 12 mm.

15. A coated optical fiber identifying apparatus according to claim 10, wherein the plurality of the protrusions are arranged in a period within a range of 0.24 mm to 0.75 mm.

16. A coated optical fiber identifying apparatus according to claim 11, wherein the plurality of the protrusions are arranged in a period within a range of 0.24 mm to 0.75 mm.

17. A coated optical fiber identifying apparatus according to claim 14, wherein the plurality of the protrusions are arranged in the optical fiber bend applying means.

18. A coated optical fiber identifying apparatus according to claim 15, wherein the plurality of the protrusions are arranged in the optical fiber bend applying means.

19. A coated optical fiber identifying method comprising:
forming a long period grating by applying a force to an optical fiber with a plurality of protrusions arranged within a range of 0.24 mm to 0.75 mm; and
determining that a light wave is propagating in the optical fiber by detecting leak light generated in the optical fiber.

20. A coated optical fiber identifying method according to claim 19, wherein the long period grating is formed by changing an angle between the plurality of the protrusions and the optical fiber.

21. A coated optical fiber identifying method according to claim 19, wherein the leak light generated in the optical fiber is detected by applying bend to the optical fiber.
